(19) United States
(12) Patent Application Publication
(10) Pub. No.: US 2006/0003108 A1
(43) Pub. Date: Jan. 5, 2006

(54) Method for production of transmission-enhancing and/or reflection-reducing optical coatings

(76) Inventors: Bernhard Zobel, Jena (DE); Bernd Gruenler, Zeulenroda (DE); Thomas Richter, Jena (DE)

Correspondence Address: JORDAN AND HAMBURG LLP, 122 EAST 42ND STREET, SUITE 4000, NEW YORK, NY, 10168, US

(21) Appl. No.: 11/111,263

(22) Filed: Apr. 20, 2005

(30) Foreign Application Priority Data
Apr. 20, 2004 (DE) 10 2004 019 575.7

(51) Int. Cl. H05H 1/26; B05D 1/08

(52) U.S. Cl. 427/446; 427/162

(57) ABSTRACT

The invention relates to a method for producing transmission-enhancing and/or reflection-reducing coatings against or on substrates by flame coating. It is based on the object of suggesting a production method for anti-reflective coatings that works in an environmentally friendly manner with the least possible complexity in terms of work time and energy. It is comprised in that a silicon-containing precursor is thermally or hydrolytically decomposed by a hydrocarbon and/or hydrogen flame using an oxidant and is applied to the substrate directly from the gas phase as an SiOₓ(OH)₍₄₋₂ₓ₎ coating, wherein 0<x≦2, and the SiOₓ(OH)₍₄₋₂ₓ₎ coating has a residual carbon content of 0 to 10%.

The invention relates to a method for producing transmission-enhancing and/or reflection-reducing optical coatings against or on substrates by flame coating.

Anti-reflection processing of substrates can be achieved either by applying a plurality of anti-reflection coatings or by applying a single anti-reflection coating. The manner in which the plurality of anti-reflection coatings works is based on the fact that an appropriate structure of coatings results in destructive interference and thus the elimination of certain reflections. Single anti-reflection coatings attempt to reduce the refractive index of the coating for reducing glass reflection if possible to a value of 1.22 and at the same time to use the roughness of the coating in order to reduce reflection. This is not possible with thick coatings. For this reason such coatings are designed to be porous, that is, with a portion of air (refraction index 1). Gradient coatings designed in this manner have a mixed refractive index between that of the coating material and that of the air.

Producing such coatings using the sol gel method is known. In this, an available organic portion of the coating is subsequently partially removed using a thermal load and thus the porous anti-reflection coating is produced; see DE 19918811 A1; EP 0835849 A1; EP 0597490 B1. Also known is producing the porous anti-reflection coatings directly using the sol gel method in that the particular structure is preformed in the sol condition (U.S. Pat. No. 4,775,520 A; DE 101466687 C1).

The disadvantage of these known methods is that sol gel processes are normally relatively complex, both in terms of applying the sols and in terms of producing the sols. In addition, expensive organic solvents are frequently used that constitute a burden on the environment. Subsequent tempering of the layers and thus additional energy consumption and increased use of time are required in many cases.

Furthermore known from DE 42 37 921 A1 for hydrophilizing a silicate glass substrate is applying a silicon-containing coating using flame-hydrolytic decomposition of the silicon organic substances. DE 100 19 926 A1 modified a surface of a compact substrate using flame-pyrolytic decomposition of silicon precursors and in this manner produces an adhesion-promoting coating on a glass or PET substrate. WO/02/14579 A1 discloses a method for producing a glass coating on a substrate in which silicon precursors (as required when using dopings) are decomposed in a flame-pyrolytic manner. The planar waveguide produced in this manner does not require additional processing. U.S. Pat. No. 5,622,750 A describes a new method for producing a planar waveguide that uses flame-pyrolytic decomposition of silicon precursors and additionally uses dopants. The sole purpose of the latter four documents is to produce hydrophilic or adhesion-promoting coatings or to produce planar waveguides.

The present invention is intended to avoid these disadvantages. It is therefore the object of the present invention to suggest a production method for single anti-reflection coatings that works in an environmentally friendly manner with the least possible complexity in terms of work time and energy.

In accordance with the invention this object is attained using the characterizing features of the first patent claim and is enhanced using advantageous embodiments in accordance with the subordinate claims. The coatings produced in this simple manner demonstrate good anti-reflection values, both when light strikes vertically and when it strikes diagonally. This is true both for the visible portion of light and for the portion of light with longer wavelengths. The use of the flame pyrolysis method, known per se, for decomposing silicon precursors for producing structured single coatings does not require the mechanical or thermal structuring of the applied coating that is needed in accordance with the prior art in connection with a sol/gel method. Thus the present invention makes possible a substantial simplification of the production process without having a negative effect on the desired transmission enhancement or reduction in reflection.

One burner or even a plurality of burners can be used for producing coatings, and their thermal output per flame area is 0.5 to 10 kW/10 cm², preferably 6 kW/10 cm². The substrate can preferably be situated within the burner flame during the production process. The substrate temperature of 20° C. to 300° C. applies to the interior of the substrate and can be higher on the substrate surface. The speed of the relative movement between burner and a substrate to be coated on one or both sides in the amount of 10 to 20000 mm/s depends on the substrate and the coating thickness to be applied. It can be 12 to 200 mm/s for glass, for instance. The distance between burner and substrate, from 3 to 200 mm, should be designed such that the substrate is disposed within the flame to the greatest extent possible. The axis of the burner is preferably oriented perpendicular to the substrate; the axis can also vary from the perpendicular by an angle of up to 45°. Silicon compounds with the general formula R₍₄₋ₙ₎SiXₙ are precursors (n=0-4; R=organic remainder; X=halogen, OH; OR; e.g. Me₄Si, Me₃Si—O—SiMe₃). An inorganic silicon compound such as e.g. SiCl₄ can also be used as precursor. The fuel gases can be liquid and/or gaseous hydrocarbons and/or hydrogen, preferably butane or propane or a mixture thereof or natural gas can be used. Air, oxygen, or a mixture of air and oxygen is used as oxidant. The coating thicknesses to be produced are between 5 nm and 200 nm, preferably between 20 nm and 100 nm. The inventive coatings have an RMS value (roughness) of 3-50 nm, preferably 5-30 nm, more preferably 10-25 nm. Both glass in the form of float glass or cast glass, coated or uncoated, with or without inlays, as well as ceramic and also plastics and also metals can be used for substrates. The advantageous effect of the optical coatings depends on the material of the substrates. The precursor concentration should be between 0.05 vol %/L fuel gas and 5 vol %/L fuel gas, preferably 0.1-1.0 vol %/L fuel gas. The percentages refer to precursors with one Si atom. For precursors with more than one Si atom per molecule, the corresponding vol % must be divided by the number of Si atoms.

The invention is described in greater detail in the following using the schematic drawings.

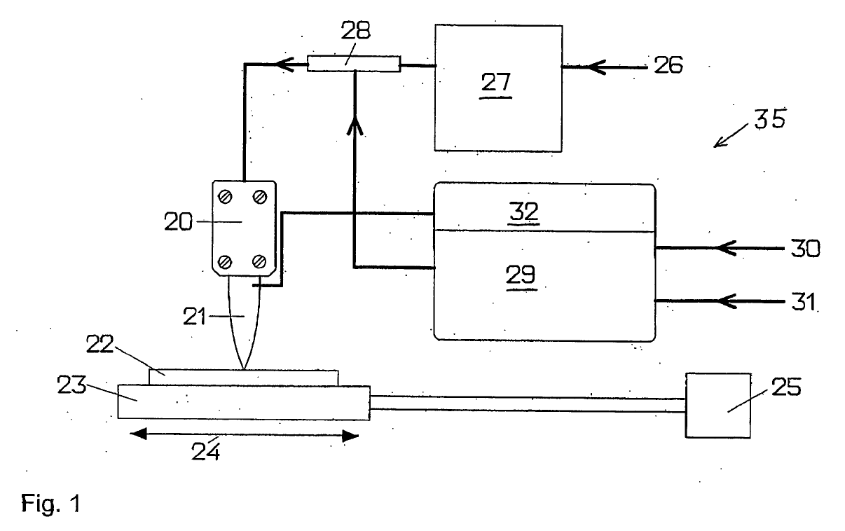

FIG. 1 is a block diagram of a coating system;

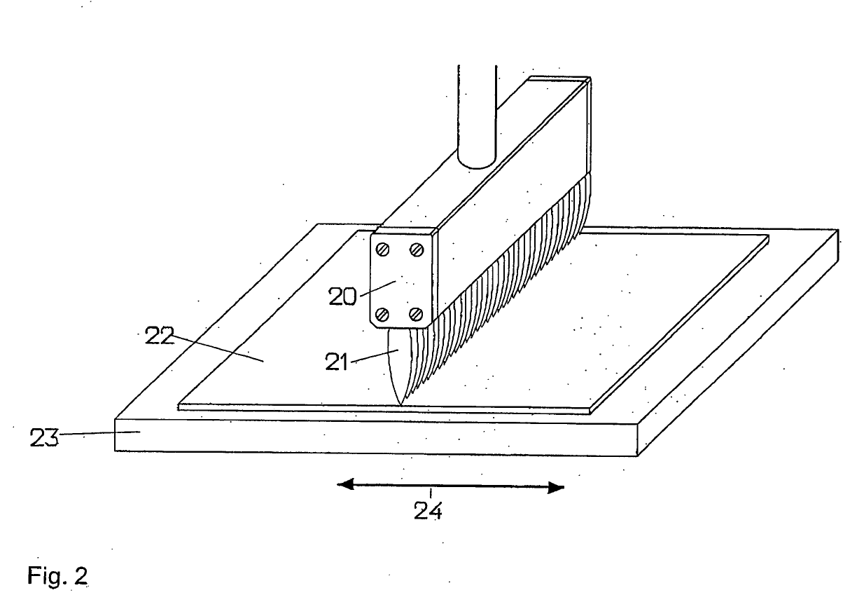

FIG. 2 is a segment of this coating system;

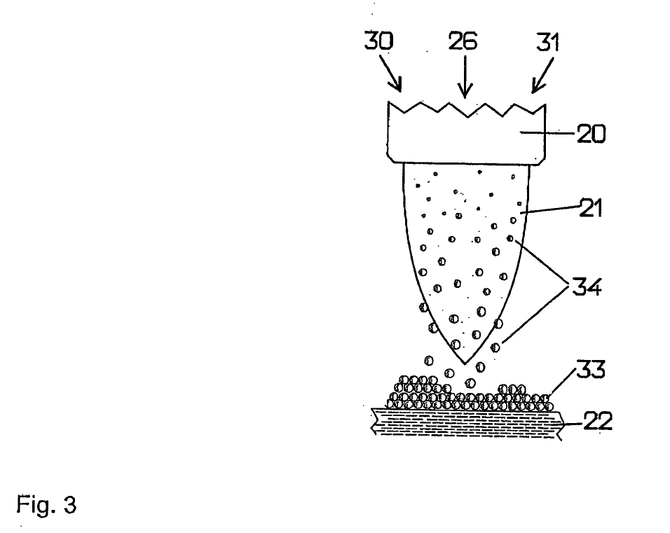

FIG. 3 illustrates the coating process;

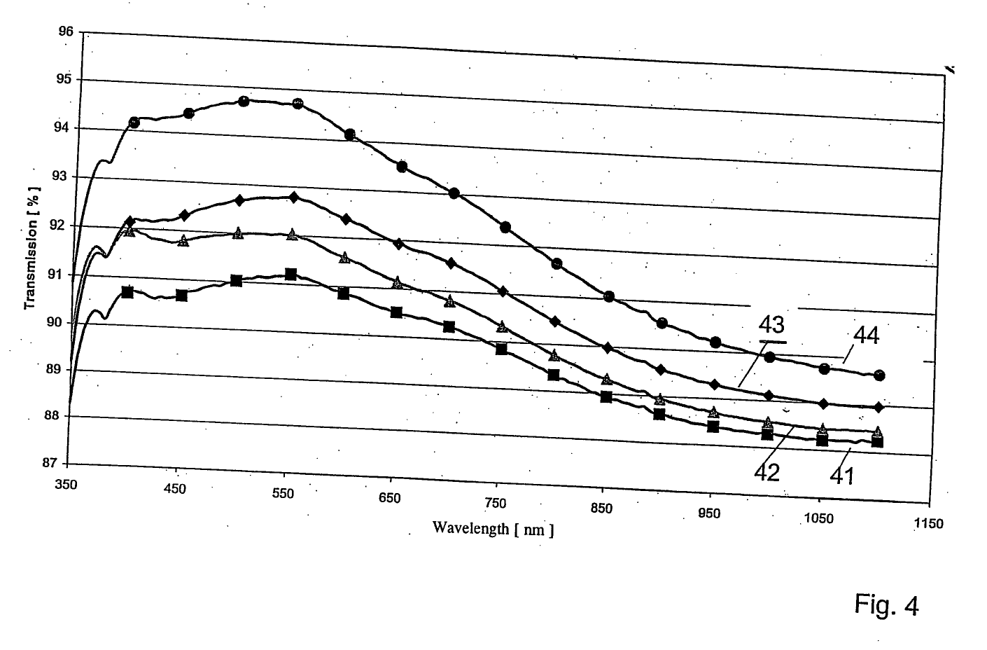

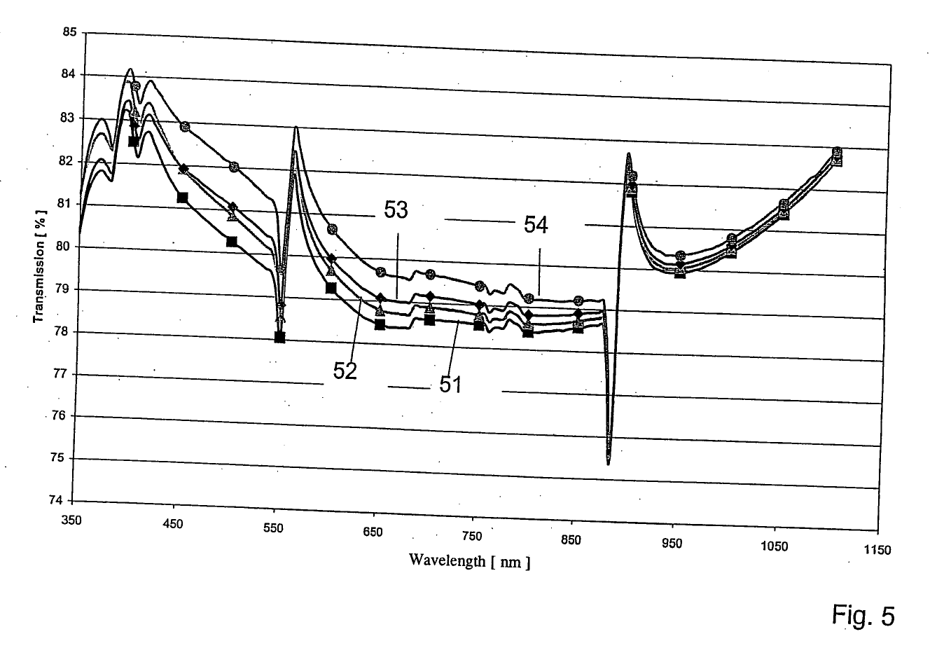

FIGS. 4 and 5 illustrate the relationship between transmission enhancement and a first substrate;

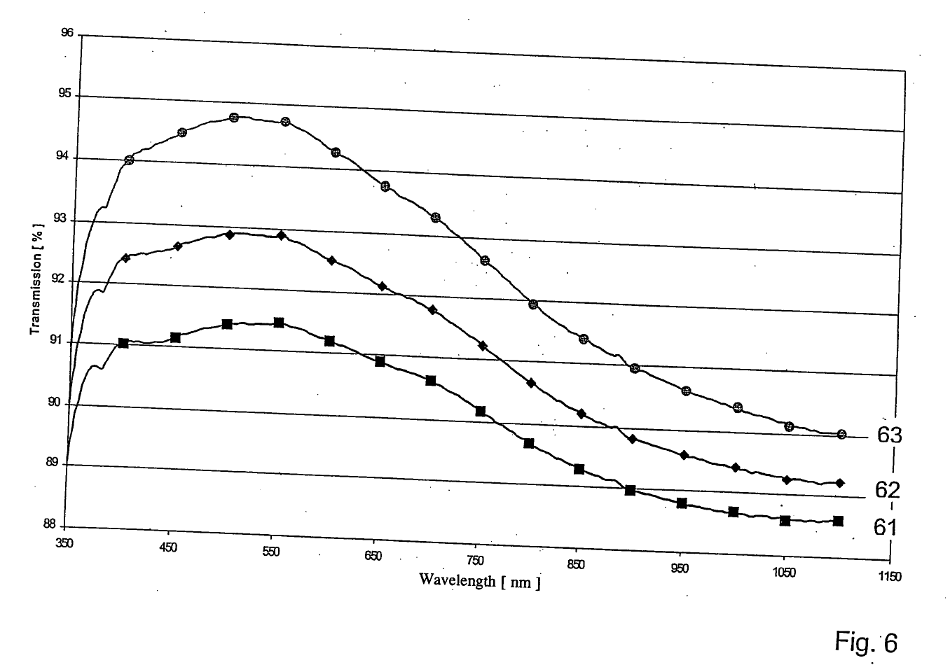

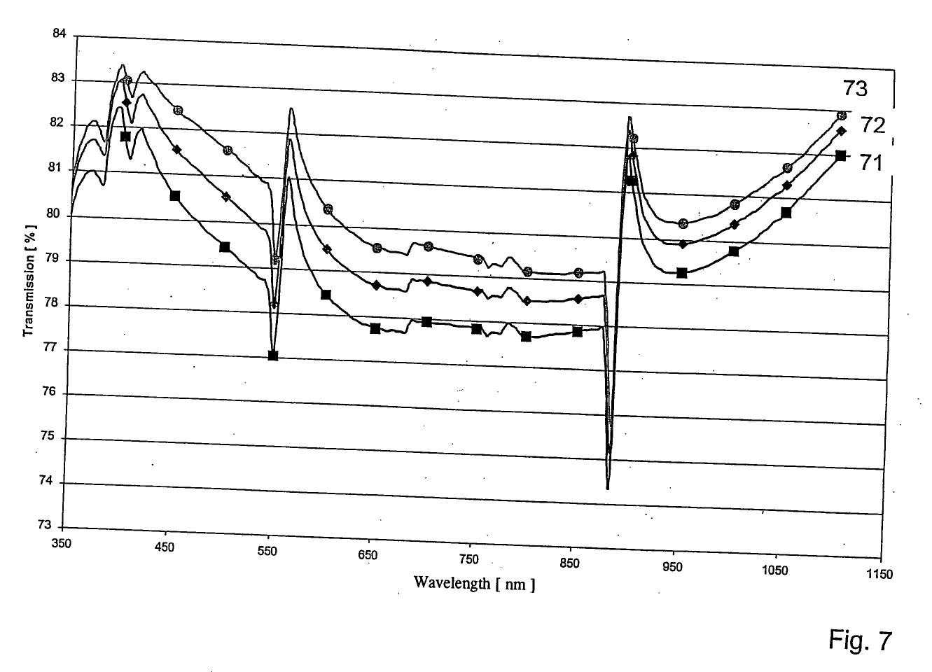

FIGS. 6 and 7 illustrate the relationship between transmission enhancement and a second substrate;

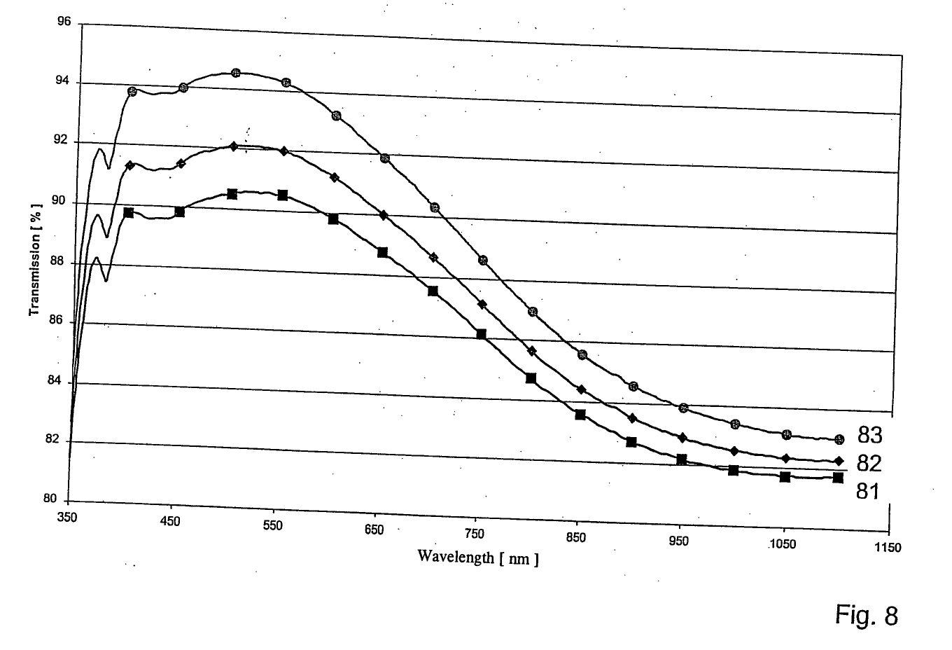

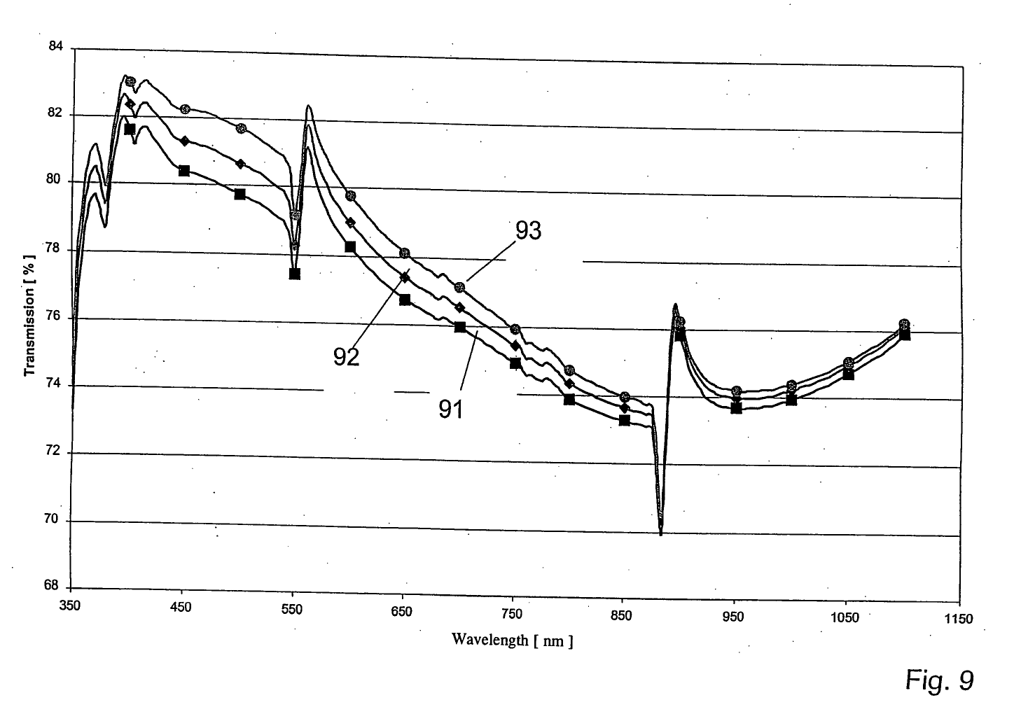

FIGS. 8 and 9 illustrate the relationship between transmission enhancement and a third substrate;

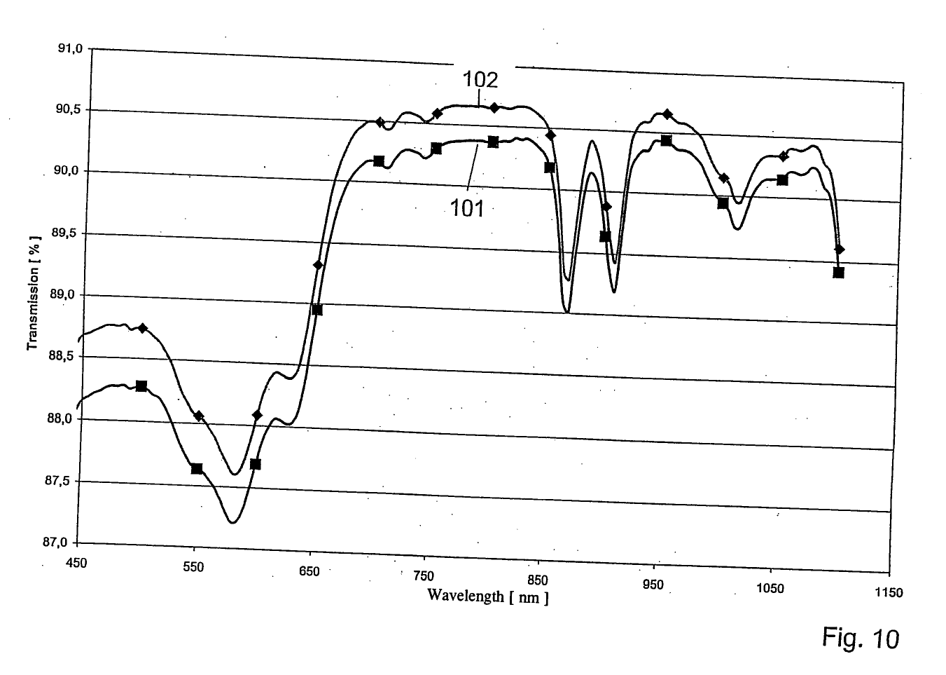

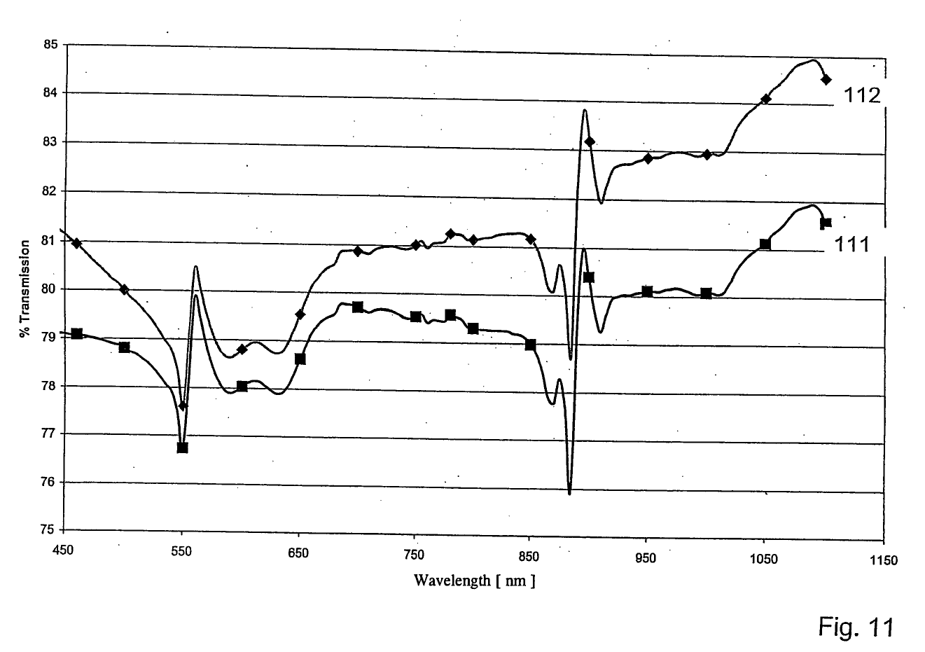

FIGS. 10 and 11 illustrate the relationship between transmission enhancement and a fourth substrate;

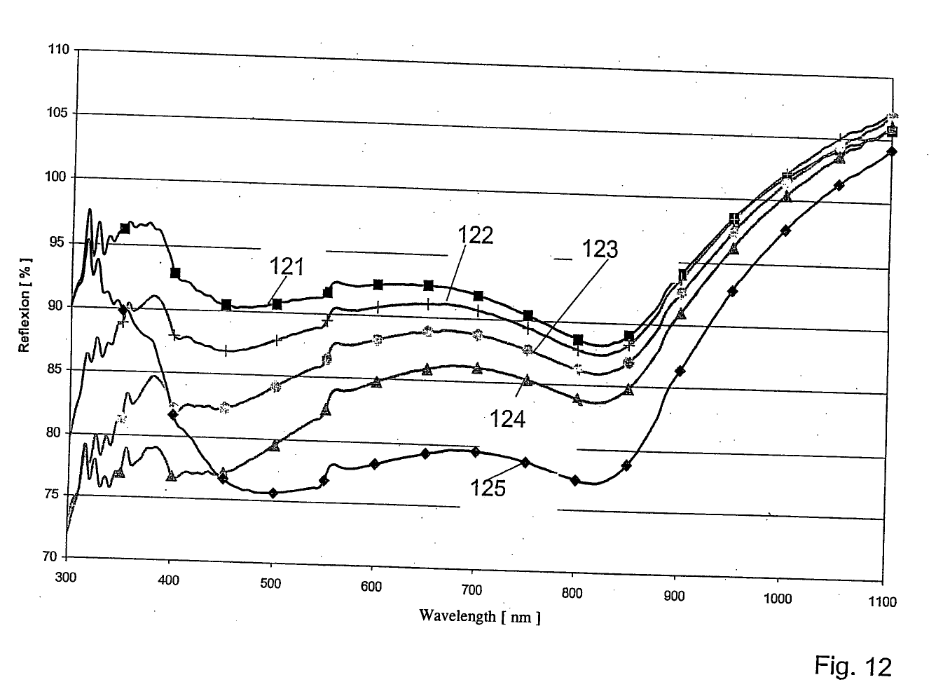

FIG. 12 illustrates the relationship between reflection reduction and a fifth substrate.

FIGS. 1 through 3 illustrate an automatic coating apparatus 35 in which a burner 20 with a flame (or a plurality of flames) 21 moves relative to a substrate 22 that is situated on a carrier 23. The substrate is disposed at a distance of e.g. 40 mm from the burner. The substrate movement is depicted by a double arrow 24. However, it is also possible that the burner or burner and substrate are moved. The temperature of the substrate 22 is regulated using a heating device 25. A precursor (e.g. Me₄Si, Me₃Si—O—SiMe₃) 26 is supplied via a metering device 27 to a mixing system 28 to which a fuel gas/oxidant regulator 29 is attached. A fuel gas (e.g. propane) 30 and an oxidant (e.g. air) 31 are mixed in an appropriate ratio in the fuel gas/oxidant regulator. The gas mixture thus produced travels into the mixing system 28 (precursor mixing) and from there into the burner 20. There the mixed gas is burned. A sensor system with display 32 monitors the burner. For producing a transmission-enhancing and/or reflection-reducing coating 33 of the appropriate thickness, the substrate 22 is moved back and forth in the direction indicated by the double arrow 24, whereby SiOₓ(OH)₍₄₋₂ₓ₎ particles 34 are deposited on the substrate 22 as a transmission-enhancing and/or reflection-reducing coating.

The precursor can also be mixed in at the burner flame, instead of in the mixing system 28, in which case it is hydrolytically decomposed using an oxidant. For reasons of clarity, FIG. 3 illustrates the substrate 22 at the tip of the flame 21. Advantageously however it is disposed within the flame 21.

The coating production on five different substrates is described in the following using 5 exemplary embodiments.

### Exemplary Embodiment 1

Using the automatic coating device illustrated in FIGS. 1 through 3, an 85-70 mm² white glass pane with a thickness of 4 mm is coated on one and both sides with an Si, O, and H-containing coating of the general composition SiOₓ(OH)₍₄₋₂ₓ₎ (x=0-2). A burner with a thermal output of 6 kW/10 cm² is used for depositing the coating. The substrate speed is 50 mm/s and the flame distance (between burner and substrate) is 40 mm. Air is used as the oxidizing medium; it is supplied at 200 L/min and is mixed with a fuel gas that comprises propane doped with 0.3 vol % hexamethyldisiloxane and is supplied at 8 L/min. The substrate is pre-heated to 80° C. in a forced-air oven upstream of the flames. During coating, a temperature plate (carrier) at 80° C. is used as counter-cooler. This procedure is performed on three identical substrates.

After cooling, the coated substrates 22 are measured spectroscopically in transmission at 90° and 45° light angles of incidence and the mean is found for each. The results in terms of enhancing wavelength-related light transmission depending on treatment and repetition thereof can be found in FIG. 4 for 90° light angle of incidence. The curve 41 represents transmission when the surfaces of the substrate are not treated. The curve 42 illustrates transmission after four passes for a substrate coated on one side. The curve 43 also illustrates transmission for a substrate coated on one side, but after 8 passes. The curve 44 illustrates transmission after 8 passes when both sides of the substrate are coated.

Given a light angle of incidence of 45°, corresponding values result that can be seen in FIG. 5 in curves 51, 52, 53, 54. As is evident, as the number of coating cycles increases and thus coating thickness increases, transmission enhancement increases as well. This effect can be doubled by coating both sides of the substrate.

### Exemplary Embodiment 2

Similar to exemplary embodiment 1, an 85-70 mm ESG pane (white glass, 4-mm thick) is coated on one side and on both sides with an Si, O, and H containing coating of the aforesaid general composition. The parameters of the burner, substrate movement, flame distance, oxidizing medium, fuel gas, preheating, and counter-cooling are the same as in exemplary embodiment 1. In this case as well the coating is repeated three times. After the substrates have cooled, transmissions are measured at 90° and 45° light angles of incidence and the mean is found for each. The relationship between transmission enhancements and 90° light angle of incidence and transmission enhancements and 45° light angle of incidence can be seen in FIGS. 6 and 7. Specifically, the curves 61, 62, 63 depict transmissions that result for a light entry angle of 90° for an untreated ESG substrate surface, for an ESG substrate surface coated on one side, and for an ESG substrate surface coated on both sides, respectively. Curves 71, 72, 73 result at a light angle of incidence of 45° for an untreated ESG substrate surface, for an EST substrate surface that has been coated on one side, and for an ESG substrate surface that has been coated on both sides, respectively, the coatings having been added with 8 passes. It is evident from FIGS. 6 and 7 that transmission enhancement can be doubled by coating both sides of the substrate.

### Exemplary Embodiment 3

In the third exemplary embodiment, a float glass pane is the substrate, and the parameters of the treatment are the same as in the preceding exemplary embodiments. The number of passes for the coating on one side and on two sides are also the same. For light angles of incidence of 90° and 45°, spectroscopically measured transmissions result that are represented in FIGS. 8 and 9. In FIG. 8, the curve 81 depicts the transmission of the uncoated substrate surface, the curve 82 depicts the transmission of the substrate surface coated on one side after 8 passes, and the curve 83 depicts the transmission of the substrate surface coated on both sides after 8 passes. The corresponding transmissions at a light angle of incidence of 45° are illustrated by curves 91, 92, and 93 in FIG. 9. These FIGUREs clearly demonstrate that the coatings enhance light transmission.

### Exemplary Embodiment 4

A polycarbonate plate that is 4-mm thick and 85-70 mm² in size is flame coated on both sides with an Si, O, and H containing coating of the aforesaid general composition. The coating occurs in 10 passes and at a speed of 500 mm/s. The flame distance, oxidizing medium, fuel gas and its supply quantity are the same as in the preceding exemplary embodiments. Preheating and counter-cooling were performed at 60° C. After the substrate has cooled, the transmission is measured spectroscopically, specifically for light angles of incidence of 90° and 45° to the substrate. FIGS. 10 and 11 illustrate the results for 90° and 45° angles of incidence; specifically the curves 101 and 111 depict the transmission of the uncoated polycarbonate plate and the curves 102 and 112 illustrate the transmission of the polycarbonate plate coated on both sides after 10 coating passes. As is evident, a demonstrable enhancement in transmission can be obtained on substrates made of plastic, as well.

### Exemplary Embodiment 5

Using the automatic coating apparatus in accordance with FIGS. 1 through 3, a 50-50 mm² 0.5-mm thick aluminum sheet is coated on its mirror side with a coating containing Si, O, and H of the aforesaid general composition SiOₓ(OH)₍₄₋₂ₓ₎ (x=0-2). Flaming occurs with 2 to 8 passes and at a speed of 50 mm/s and a flaming distance of 40 mm. An air current of 200 L/min is used for oxidizing medium. The air is mixed with a fuel gas that comprises 0.3 vol % hexamethyldisiloxane-doped propane and is supplied at 8 L/min. The substrate is preheated to 80° C. in the forced-air oven prior to flaming. During coating, a tempering plate at 80° C. is used for counter-cooling. After cooling, the coated substrate is measured spectroscopically in terms of reflection using an Ulbricht sphere at an 8° incline. The reduction in reflection is up to 15% and can be seen from FIG. 12. The curve 121 depicts the reflection of the uncoated aluminum substrate. The curve 122 illustrates reflection after one coating pass. The curve 123 illustrates reflection after two coating passes. The curve 124 results when there are four coating passes, and the curve 125 when there are eight coating passes. Overall a clear reduction in reflection is evident as a function of the coating and/or coating thickness.

All of the features represented in the specification, in the following claims, and in the drawings can be essential to the invention both individually and in any combination.

Legend
20 Burner
21 Flame (flames)
22 Substrate
23 Carrier
24 Double arrow
25 Heating device
26 Precursor
27 Metering device
28 Mixing system
29 Fuel gas/oxidant regulation
30 Fuel gas
31 Oxidant
32 Sensor system with display
33 Coating
34 Particle
35 Coating apparatus
41, 42, 43, 44, 51, 52, 53, 54, 61, 62, 63, 71, 72, 73, 81, 82, 83, 91, 92, 93, 101, 102, 111, 112, 121, 122, 123, 124, 125 Curves

1. Method for producing transmission-enhancing and/or reflection-reducing optical coatings on substrates by flame coating, comprising:
thermally and/or hydrolytically decomposing a silicon-containing precursor with a flame created by a fuel comprising at least a hydrocarbon and/or hydrogen and by an oxidant; and
applying said precursor to said substrate directly from the gas phase as an SiOₓ(OH)₍₄₋₂ₓ₎ coating, wherein
0<x≦2,
the SiOₓ(OH)₍₄₋₂ₓ₎ coating has a residual carbon content of 0 to 10%, and
at least one burner is utilized to produce said coating.

2. Method in accordance with claim 1, wherein to produce said coating, said substrate is introduced into said flame.

3. Method in accordance with claim 1, wherein prior to and/or during production of said coating, said substrate is heated to 20 to 300° C.

4. Method in accordance with claim 1, wherein said coating has a thickness of 5 to 200 nm.

5. Method in accordance with claim 1, wherein said precursor comprises an organic silicon compound.

6. Method in accordance with claim 1, wherein said precursor comprises an inorganic silicon compound.

7. Method in accordance with claim 1 or 4 or 19, wherein for a precursor with one Si atom per molecule, a precursor concentration of 0.05 to 5 vol %/L fuel gas is used, said precursor concentration being proportionately less for a precursor having more than one Si atom per molecule.

8. Method in accordance with claim 1, wherein said fuel comprises butane or propane or a mixture thereof.

9. Method in accordance with claim 1, wherein said fuel comprises natural gas.

10. Method in accordance with claim 1, wherein said oxidant comprises air, oxygen, or a mixture thereof.

11. Method in accordance with claim 1, wherein the distance between said burner and said substrate is set to 3 to 200 mm.

12. Method in accordance with claim 1, wherein to produce said coating, said burner and/or said substrate are moved relative to one another once or a plurality of times.

13. Method in accordance with claim 1, wherein a said burner has a thermal output of 0.5 to 10 kW/10 cm², at a flame area.

14. Method in accordance with claim 1, wherein said at least one burner comprises a plurality of burners.

15. Method in accordance with claim 1, wherein said coatings produced have a roughness corresponding to an RMS of 3 to 50 nm.

16. Method in accordance with claim 1, wherein said substrate comprises at least one of glass, ceramic, plastic, or metal.

17. Method in accordance with claim 1, wherein said burner and/or said substrate move relative to one another such that said relative movement is between 10 and 20000 mm/s.

18. Method in accordance with claim 3, wherein said substrate is heated to 60 to 120° C.

19. Method in accordance with claim 4, wherein said coating thickness is from 20 to 100 nm.

20. Method in accordance with claim 7, wherein said precursor concentration is from 0.1 to 1.0 vol %/L fuel gas for a precursor with one Si atom per molecule, said precursor concentration being proportionately less for a precursor having more than one Si atom per molecule.

21. Method in accordance with claim 11, wherein the distance between said burner and said substrate is set to 10 to 60 mm.

22. Method in accordance with claim 13, wherein said burner has a thermal output of 6 kW/10 cm² at said flame area.

23. Method in accordance with claim 15, wherein said coatings produced have a roughness corresponding to an RMS of 10 to 25 nm.

24. Method in accordance with claim 6, wherein said inorganic silicon compound comprises SiCl₄.
